(19) United States
(12) Patent Application Publication
(10) Pub. No.: US 2005/0064080 A1
(43) Pub. Date: Mar. 24, 2005

(54) High fiber high protein ready-to-eat cereal

(76) Inventors: Dean W. Creighton, Brooklyn Park, MN (US); Barrie R. Froseth, Plymouth, MN (US); Daniel R. Green, Minnetonka, MN (US); Timothy O. Hansen, Coon Rapids, MN (US); Xia Liu, Plymouth, MN (US)

Correspondence Address: GENERAL MILLS, INC., P.O. BOX 1113, MINNEAPOLIS, MN, 55440, US

(21) Appl. No.: 10/669,238

(22) Filed: Sep. 24, 2003

(51) Int. Cl. A21D 10/00

(52) U.S. Cl. 426/549

(57) ABSTRACT

Disclosed are cooked dried farinaceous food products such as cooked cereal doughs, ready-to-eat cereals and grain based snacks fabricated from such cooked cereal doughs containing high levels of both insoluble and soluble fiber as well as high levels of protein. The cereals contain about 5 to 15% (dry weight) insoluble fiber; 5% to 15% soluble fiber in an excess of insoluble fiber; 15% to 30% (dry weight) plant protein and the balance cereal ingredients especially rice and wheat flour. The soluble fiber is preferably provided at least in part by inulin ingredient that can be incorporated into the dough and/or topically applied.

### BACKGROUND OF THE INVENTION

The present invention relates to food products and to their methods of preparation. More particularly, the present invention relates to ready-to-eat cereal products of high protein and high fiber content and to their methods of preparation.

R-T-E cereals are popular packaged goods food items. R-T-E cereals exist in large numbers of varieties. R-T-E cereals, especially whole grain, are known as good sources of fiber. A good description of the literature pertaining to the health discussion on the role of fiber is found in U.S. Pat. No. 4,777,045 (issued Oct. 11, 1988 to Vanderveer et al. and is entitled High Bran Snack).

High-fiber ready-to-eat (“R-T-E”) cereals with high levels of soluble fiber are described in U.S. Pat. No. 5,024,996 entitled R-T-E Cereal with Soluble Fibers (issued Jun. 18, 1991 to Mitchell Ringe). The cereal compositions described comprises an excess of soluble and insoluble fiber. Cereal products fortified with inulin as a soluble fiber source are described in U.S. Pat. No. 6,149,965 “Cereal Products with Inulin and Methods of Preparation” (issued Nov. 21, 2002 Bernhard van Lengerich et al.).

The present invention provides high levels of predominantly insoluble fiber and in is an improvement upon those compositions described in the '996 and '965 patents.

In view of the health interest in fiber, high fiber cereals are increasingly popular. These cereals contain added levels of fiber sources, especially corn (maize) and wheat bran, and range generally from about 2-5 g fiber/oz cereal. Generally, the fiber is predominantly of the insoluble type. Some cereals are formulated from all bran sources and can contain up to 8-10 g/oz fiber. High fiber cereals using purified insoluble fiber sources and artificial sweeteners can even contain as high as 8-13 g fiber/oz of cereal.

While popular, high fiber cereals are not without disadvantages. The primary concern is with the organoleptic qualities of the R-T-E cereal. Generally, as the concentration of fiber increases, the starchy components decrease, adversely affecting the cereal's organoleptic and physical properties. Cereals high in insoluble fiber are often dry, exhibit short bowl lives and yield highly frangible food pieces.

Other high fiber food products containing other fiber sources are well known. For example, U.S. Pat. No. 4,568,557, to Becker et al., discloses a snack food product prepared by premixing a dietary fiber with a food grade oil; premixing a compound coating containing a fractionated fat, sweetener, milk solids, yogurt, and a flavoring agent; blending the two pre-mixtures and adding a cereal product and a dried fruit or nut for flavor; and extruding the resulting mixture into a desired shape.

European patent application No. 0068229, to Kleinert, discloses the addition of the seed coats (episperm) of cocoa beans in finely powdered form, to dough, bread, snacks, and chocolate to increase bulk and stimulate the intestinal tract.

U.S. Pat. No. 4,348,379, to Kowalsky, discloses a dietetic composition for natural digestion regulation containing whole fleawort seeds (Semen psyllii totum) whole linseed, wheat bran, lactose, a binding agent based on natural rubber, flavor and food color additives. The preferred binding agent is gum arabic.

While most fiber rich R-T-E cereals have higher levels of insoluble fibers, present consumer interest is focused upon cereals containing oat bran which is a rich source of soluble fiber. There is a growing awareness of the health benefits to people associated with soluble fiber consumption, especially reductions in blood serum cholesterol, i.e., antihypercholesterolemic benefits. Unfortunately, cereals high in soluble fibers typically are gummy or slimy upon consumption.

Several patents teach the use of psyllium for use in R-T-E cereals. (See, for example, U.S. Pat. No. 5,026,689 entitled “R-T-E Cereal With Psyllium,” issued Jun. 25, 1991 to M. Ringe). Psyllium is a good source of soluble fiber. The whole wheat based flake R-T-E cereals therein described are of high eating quality even though containing high levels of soluble fiber by virtue of particular insoluble to soluble fiber ratios. Notwithstanding the improvements in R-T-E cereal flavor and texture, commercial products based upon the '689 patent have met with limited consumer acceptance. Various recent attempts have been made to treat psyllium to make it more palatable in R-T-E cereals or to otherwise process R-T-E cereals containing psyllium with little consumer success.

While it is difficult to provide even a single type of fiber fortified R-T-E cereal, such as a whole wheat flake that exhibits acceptable texture and flavor to consumers, it is even more difficult to provide a wide variety of R-T-E cereals fortified with high levels of soluble fiber.

The present invention is directed towards the provision of an improved high fiber R-T-E cereal with superior organoleptic attributes or qualities. Surprisingly, the present invention provides such a superior quality high fiber R-T-E cereal that nonetheless contains a high concentration of soluble fiber. The present invention resides in part in the particular selection of inulin as the soluble fiber source.

Inulin is a well known material long used as a food supplement. Inulin is a carbohydrate material derived from a variety of crops importantly from Jerusalem artichoke and chicory. However, inulin is known for use as a prebiotic, that is, a food material that is metabolized in the intestine by desirable bacteria such as bifidus and lactobacillus. The promotion of desirable intestinal flora is thought to be related to a variety of health benefits.

In addition to providing high levels of fiber, the present cereal compositions additionally comprise high levels of protein. While providing consumer acceptable high fiber R-T-E presents formidable challenges, providing such high fiber cereals that are also high in protein content is even more difficult since the amount of starchy constituent is necessary decreased in direct proportion to the increases in fiber and protein.

Notwithstanding the high levels of both fiber and protein, the present cereal compositions provide R-T-E cereals especially those in flake form that exhibit good organoleptic eating qualities in addition to their desirable nutritional profile of high fiber and protein content.

Surprisingly, a wide variety of high soluble fiber R-T-E cereal products can be provided that are almost indistinguishable in taste and texture from their counterparts that are not fortified with fiber when that fiber is supplied by inulin. Such high fiber high quality R-T-E cereals can be provided from cooked cereal doughs that are fortified with soluble fiber provided by inulin within certain concentrations. In its method aspect, the present invention provides methods for preparing such novel R-T-E cereal products.

### BRIEF SUMMARY OF THE INVENTION

The present invention provides protein and fiber fortified cooked cereal dough compositions high in both total fiber and protein and to dried cereal finished food products fabricated therefrom as well as methods for preparing such fortified cooked cereal compositions and dried cereal finished food products.

The dried cereal finished products are fabricated from cooked cereal doughs comprising conventional cereal ingredients and sufficient amounts of at least one insoluble dietary fiber ingredient to provide a total insoluble fiber content of about 5-15% (dry weight). The dried finished cereals additionally comprise about 5% to 15% (i.e., up to about 3 g/oz) of added or supplemental inulin. The weight ratio of total insoluble to total soluble fiber ranges from about 1:1. to about 1.5:1. The dried finished cereals additionally comprise sufficient amounts of a plant protein ingredient to provide a total protein content of about 15% to 30% (dry weight).

Notwithstanding concentrations of the inulin soluble fiber and the absence of added fat, the finished fortified cereal products are not only organoleptically desirable but almost indistinguishable from their unfortified counterparts.

In preferred embodiments, the present cooked cereal dough products are substantially free of added fat such as hydrogenated soybean oil and are in the form of dried R-T-E cereal flakes

In its method aspect, the present invention resides in methods for preparing the present high fiber and high protein containing cereal compositions and finished R-T-E products prepared therefrom. In one embodiment, the methods comprise
A. providing a cooked cereal dough or mass containing inulin;
B. forming the cereal dough into pieces; and
C. drying the cereal pieces to form the present grain based finished food products fortified with inulin. In another embodiment all or at least a portion of the inulin is topically applied to the piece prior to finish drying.

### DETAILED DESCRIPTION OF THE INVENTION

The present invention relates to cooked cereal doughs containing high levels of both fiber and protein, to finished dried grain based products prepared therefrom especially R-T-E cereals and to methods for their preparation. Each of these product constituents, as well as methods for their preparation and use are described in detail below. Throughout the specification and claims, percentages are by weight (dry basis) and temperatures in degrees Centigrade, unless otherwise indicated. All patents or applications referenced are hereby incorporated by referenced.

Cereal ingredient(s)

The first essential component of the present cereal compositions is a starchy cereal(s). The cereal component can comprise any conventionally employed starchy cereal or, synonymously, farinaceous material, for use in a ready-to-eat cereal. Exemplary suitable starchy cereals include cereal flours from major cereal grains including wheat, rice, corn (maize), oats, barley, rye, or and mixtures thereof. For example, the other cereal grains can be supplied by such minor grains as triticale or by “heritage” grains such as spelt, kamut, quinoa and mixtures thereof. While not produced in large quantities, such heritage grains are especially popular among those interested in organic foods. The flours can be whole flours or flour fractions such as with the germ fraction or husk fraction removed. Of course, the R-T-E cereal art is well developed and the skilled artisan will have no difficulty selecting suitable farinaceous materials for use herein

Especially preferred for use as a farinaceous component in the present cereal compositions is a cereal ingredient selected from the group consisting of rice, wheat, and mixtures thereof. Preferred for use herein is a mixture of rice and wheat. Most preferred is an approximately equal mixture of rice and wheat with a small preponderance of rice in view of the organoleptic attributes of rice flour in R-T-E cereals.

Desirable starchy cereal component concentrations can range widely and the starchy cereal component can comprise from about 25% to about 50% of the cereal composition. The starchy cereal component includes not only pure added cereal flours or other granulations but also that starchy fraction provided by other cereal ingredients such as bran or zein. Better results in terms of organoleptic attributes and reductions in R-T-E cereal piece frangibility are obtained when the starchy cereal fraction comprises about 30% to 45% of the composition. For best results the starchy cereal fraction comprises about 45% to 40% of the present cereal compositions.

Insoluble Fiber

The cooked cereal dough compositions additionally comprises sufficient amounts of at least one insoluble dietary fiber ingredient to provide a total insoluble fiber content of about 5-15% (dry weight). The insoluble fiber ingredient is desirably high in total insoluble fiber so as to provide the desired levels of insoluble fiber. Preferred for use herein due to its high insoluble fiber content and low cost is corn bran. Good results are obtained when the present cooked dough cereal compositions comprise about 8% to 12% corn bran. In preferred variations, the corn bran ingredient is milled to provide the corn bran in the form of a fine powder to minimize texture degradation. Good results are obtained when the corn bran is milled to pass through a US Standard Size No. 40 screen (i.e., 420 micron screen opening), preferably through a US Standard Size 200 screen (i.e., through a 74 micron size screen). Corn bran typically includes about 8% to 12% of insoluble fiber, 6-10% protein and the balance of the corn bran of corn starchy fraction.

In certain embodiments, a portion of the insoluble fiber ingredient can be provided by carboxymethyl cellulose. If present, the carboxymethyl cellulose can be present in levels ranging from about 0.1 to about 1% of the present cereal compositions.

Soluble Fiber

The cooked cereal dough compositions additionally comprises about 5% to 15% (dry weight) of soluble fiber. Preferred for use herein to supply the soluble fiber constituent(s) level is a fruto oligo saccharide (“FOS”) material. Inulin is a particularly useful FOS material due to its cost and ready availability in commercial quantities and convenient grades. Inulin is well known and is a staple of commerce. In preferred form, pure inulin is employed rather than less pure vegetable sources of inulin such as Jerusalem artichoke powder. Inulin is available in a wide variety of grades and forms including both as a dry powder and in liquid form as a concentrated solution.

Generally, inulin is the clean, dried fibrous material that is separated by extraction from, for example, chicory, onions and Jerusalem artichokes and other common plant sources. Inulin is available in various commercial grade varieties. Pure inulin is commercially available from, for example, Rhone-Poulenc in the U.S. under the trade name RAFTILINE® and from Imperial Suicker Unie, LLC in Europe. Pure inulin has an average degree of polymerization (“DP”) of about 9 to 10. Less preferred for use herein are less pure inulin source materials such as a dried Jerusalem artichoke flour, deflavored onion flour and mixtures thereof. Also useful herein are oligofructose materials available under the RAFTILOSE trade name from Rhone-Poulenc. Such materials are plant derived and have a DP of about 2 to 7, i.e., with fructose claims of up to about seven fructose units. However, in other embodiments inulin material of larger molecular weight, e.g., having a DP of 9-17, can also be used.

FOS materials are also available commercially such as from GTC Nutrition Company, Westminster, Colo. FOS materials have an average degree of polymerization (“DP”) ranging from about 2-4 polyfructans. Due to their lower molecular weight, the FOS materials have a greater solubility in water. FOS materials have a slight sweetness to their taste. A further advantage is that the FOS materials when topically applied form a clear, almost undetectable coating. As a result, FOS materials are especially suitable for topical application.

In the present cereal compositions and products, in the preferred embodiment a majority of the inulin is included in the formulation in the cereal composition as compared to in the form of a topical application although having a portion of the inulin forming a topical application as part of a topical application is also contemplated herein.

The present compositions can optionally include additional or supplemental sources of soluble fiber in addition to inulin. One possible, although expensive, source of soluble fiber is to employ commercially available high methoxyl pectin. While desirable due to its cost and availability, the utilization of pectin aggravates the problems of providing organoleptically acceptable cereal products. Accordingly, when pectin is used to provide additional soluble fiber, generally lower amounts of soluble fiber are preferred. Other useful sources of soluble fiber include oat bran, guar gum, carboxymethyl cellulose, psyllium and mixtures thereof. However, inulin is the ingredient of choice in providing the soluble fiber levels for the present compositions and products.

Also useful herein are non-cereal fiber sources including cellulose flour, cellulose fiber, sugar beet fiber, etc. Sugar beet fiber can comprise up to 80% total dietary fiber with about 20% soluble fiber and 60% insoluble fiber. If employed, sugar beet fiber can comprise about 0.1 to 5% (dry weight) of the present products.

The present compositions can optionally include additional or supplemental sources of soluble fiber in addition to inulin. One possible, although expensive, source of soluble fiber is to employ commercially available high methoxyl pectin. While desirable due to its cost and availability, the utilization of pectin aggravates the problems of providing organoleptically acceptable cereal products. Accordingly, when pectin is used to provide additional soluble fiber, generally lower amounts of soluble fiber are preferred. Other useful sources of soluble fiber include oat bran, guar gum, carboxymethylcellulose, psyllium and mixtures thereof.

If present, each of these supplemental soluble fiber sources can comprise from about 0.1 to 6% dry weight basis, and, preferably, when used in addition to inulin, about 1 to 5% of the present compositions, and for best results about 1 to 2%.

Also useful herein are non-cereal fiber sources including cellulose flour, cellulose fiber, sugar beet fiber, etc. Sugar beet fiber can comprise up to 80% total dietary fiber with about 20% soluble fiber and 60% insoluble fiber. If employed, sugar beet fiber can comprise about 0.1 to 5% (dry weight) of the present products.

The measurement of total dietary fiber, soluble fiber, and insoluble fiber is subject to disparate analytical methods and values determined thereby. For purposes of the present invention, “soluble” and “insoluble” fiber values are to be determined by an accepted test procedure for fiber developed by Prosky et al. and described in “Determination of Insoluble, Soluble and Total Dietary Fiber in Foods and Food Products,” Journal of the Association of Official Analytical Chemists, Vol. 71, No. 5 (1988) which is incorporated herein by reference. The procedure there described involves an enzymatic-gravametric procedure adopted by final action of the AOAC.

Vegetable Protein

The cooked cereal dough compositions additionally comprise sufficient amounts of a plant protein ingredient to provide a total protein content of about 15% to 30% (dry weight), preferably about 20% to 25%. Plant protein sources can include soy protein, soy flour especially defatted soy meal, soy protein isolate, wheat zein, corn zein and mixtures thereof. Corn zein and wheat zein are the protein isolates derived from corn and wheat respectively and are well know commodity ingredients. For those embodiments where high quality protein is desired, the plant protein is preferably provided by or primarily by soy flour, soy protein, soy protein isolate and mixtures thereof. In other embodiments where selection of low cost ingredients is important, the plant protein is preferably provided by corn zein and wheat zein or non vital wheat gluten, and mixtures thereof. In the preferred embodiment, at least a majority of the protein is provided by corn or wheat zein. In one preferred embodiment balancing cost and high quality protein, defatted soy meal is the preferred protein ingredient. In other embodiments where the best possible flavor is desired, then the protein ingredient can be supplied by high sucrose defatted soy meal such as is available from the Dupont Company.

The present cooked cereal dough compositions and dried finished products prepared therefrom can additionally include one or more cereal bran fractions as a supplemental fiber ingredient. Among cereal brans, oat bran is an especially desirable optional ingredient in the present cereal compositions. Oat bran has a fiber fraction in addition to the high cereal or starchy fraction. Oat bran is a concentrated source of a soluble fiber and can comprise at least 6% soluble fiber (about 1.7 g/oz) as well as at least 6% insoluble fiber (about 1.7 g/oz). Accordingly, inclusion of oat bran into the present R-T-E cereal composition simultaneously can provide the present essential starchy cereal component, a supplemental soluble fiber component, and an insoluble fiber component. If desired, the cereal bran ingredient can comprise about 1 to 50% (dry weight) of the cooked cereal dough. High fiber products will preferably contain about 25 to 40% supplemental cereal bran. Low fiber products can preferably contain about 1 to 15% supplemental cereal bran.

Sugar

In less preferred embodiments, the present cereal dough composition can additionally comprise about 0.1 to about 20% (dry weight) by weight sugar(s) or, synonymously herein, added nutritive carbohydrate sweetening agents. Such materials are also well known in the R-T-E cereal art. Useful herein as the sugar component is sucrose. However, the sugar(s) component can additionally comprise conventional fructose, maltose, dextrose, honey, fruit juice solids, brown sugar, and the like. In addition to providing desirable sweetness, the sugar component additionally beneficially affects the cereal color and texture. Better results are obtained, especially for R-T-E cereal products, when the sugar(s) component comprises from about 2% to about 10% by weight of the composition. In preferred embodiments, the present dried cooked cereal dough and products prepared therefrom are desirably free of added nutritive carbohydrate sweetening agents. In more preferred embodiments, the sugar content of the extruded cooked cereal dough is less than about 5% (dry weight) although products prepared from such low sugar cooked cereal doughs can additionally include a sweetener coating including higher levels of sugar(s).

Fat

Of coarse, some level of native cereal grain fat constituents are provided by the cereal ingredients employed herein. In a preferred embodiment for ready-to-eat cereals, the present cooked cereal dough cereal compositions can be further defined in part by low added fat levels, i.e., the present cereals do not comprise added or absorbed fat. Thus, the total fat or lipid component is quite low. The fat content results from the native fat associated with the starchy cereal component(s). Permissible low fat additions can also result from adding emulsifiers and from vitamin or flavor addition. However, the total fat content of the cereal compositions is preferably less than about 3%, preferably less than about 2%. Preferably, the R-T-E cereal is substantially free of any fat or oil incorporated into the cooked cereal dough. Such “added fat” is to be distinguished from “absorbed fat” that is picked up during deep fat frying used to prepare finished snack products herein. In more preferred embodiments, R-T-E cereals are further characterized as free of any absorbed fat. In other variations, the pieces can include a coating that can contain an added fat ingredient particularly those coating that additionally include a particulate flavoring such as cinnamon or dry peanut butter flavor.

Adjuvant Ingredients

If desired, the present cereal dough composition can additionally include a variety of materials designed to improve the aesthetic, organoleptic or nutritional qualities of the cereal. These adjuvant materials can include vitamin and/or mineral fortification, colors, flavors, high potency sweetener(s), and mixtures thereof. The precise ingredient concentration in the present cereal composition will vary in known manner. Generally, however, such materials can each comprise about 0.01% to about 5%, preferably about 0.1% to 2% dry weight of the cereal composition.

Fiber, especially insoluble fiber, is believed to adversely affect selected mineral and vitamin absorption. Accordingly, in highly preferred embodiments, in particular, the present R-T-E cereals can be fortified with bioavailable sources of calcium, iron, riboflavin and the like. These mineral fortifiers can be incorporated into the cereal compositions directly. It is also desirable to vitamin fortify the present R-T-E cereals, especially selected B vitamins, e.g., riboflavin. Conventional methods and techniques of vitamin fortification can be used herein. Due in part to their heat sensitivity, vitamin fortification is typically practiced by topical application to the R-T-E cereal and such a technique is preferred herein.

If desired, the present R-T-E cereal composition can additionally include a variety of materials designed to improve the aesthetic, organoleptic or nutritional qualities of the cereal. These adjuvant materials can include vitamin and/or mineral fortification, colors, flavors, high potency sweetener(s), and mixtures thereof. The precise ingredient concentration in the present cereal composition will vary in known manner. Generally, however, such materials can each comprise about 0.01% to about 2% by weight of the cereal composition

One especially useful material is common salt that functions, in part, as a flavor enhancer. Desirably, the salt comprises about 0.1% to 2%, preferably about 0.5% to 1.5% of the cereal composition.

Still another highly preferred ingredient is a malt syrup flavor ingredient. The malt syrup comprises about 1 to 8% (dry basis), preferably about 2 to 5%.

A preferred adjuvant material is a high potency sweetener. Preferred for use herein as the high potency sweetener is an ingredient selected from the group consisting of aspartame, sucralose, potassium acesulfame, and mixtures thereof. Alitame, neotame saccharin and cyclamates can also be employed. Thaumatin can also be used and provides the advantage of flavor masking off flavors. Also useful herein are trehelose, taglatose and mixtures thereof. Preferred for use herein are heat resistant or temperature stable sweeteners such as sucralose, potassium acesulfame since such materials can conveniently be added together with the balance of other materials and subjected to a cereal cooking step with minimal loss of sweetness. However, these sweeteners together with aspartame which is a more heat susceptible sweetener can also be topically applied to provide desired levels of sweetness.

The cooked cereal dough compositions of the present invention can be in a variety of forms. For example, the cooked cereal dough compositions can be in the form of a dough having a moisture content of about 10% to about 35%. The dough can be in the form of a high moisture dough such as exiting a batch cooker or twin screw extruder having a moisture content of about 15% to 35%. In other variations, the cooked cereal dough compositions can be in the form of a partially dried or lower moisture content dough product such as in the form of a dough suitable for forming into pieces or pellets. In still other variations, the cooked cereal dough can be in the form of dried pellets suitable for forming into wet flakes or other shapes. In still other variations, the cooked cereal dough compositions can be in the form of dried cereal products such as toasted flakes or puffed “O's” or other puffed shapes having a moisture content of about 2-6% suitable for use as an Ready-to-eat cereal. In still other variations, the dough can be in the form of flat sheets or ribbons that can be cut into squares or formed into multiple layered configurations such as biscuits. In still other variation, the compositions can be in the form of cereal bar products fabricated from particles of dried cooked cereal dough bound together by a binder such as a sugar syrup binder.

In preferred form, the cooked cereal dough products are in the form of dried pellets having a moisture content of about 15-20% suitable for forming into wet flakes, in the form of wet flakes having a moisture content of about 15-20% suitable for toasting and frying, and most preferably in the form of toasted and dried flakes suitable for use as an R-T-E cereal. The dried pellets can be milled to form wet flakes having a thickness ranging from about 0.015 to 0.3 inch (380-760 micron) and can be toasted to form dried and toasted flakes having a moisture content of about 2-6%. Conveniently, the flakes can have a piece count of a bout 1-10 per gram. The dried flakes can include a topical coating such as a sweetener coating. The sweetener coating can include various nutritive carbohydrate sugars or high potency sweeteners or mixtures thereof. In preferred form, the topical coating additionally includes a FOS material especially inulin having a DP within the preferred range herein.

Method of Preparation

Providing A Cooked Cereal Dough

In the preferred embodiment, the present methods essentially comprise a first step of providing a cooked cereal composition such as a cereal dough or cereal mass containing the cereal, insoluble fiber, soluble fiber and protein ingredients within the herein specified ranges.

As is well known, a cooked cereal dough can be prepared by blending various dry cereal ingredients together with water and cooking to gelatinize the starchy components and to develop a cooked flavor. The cooked material can also be mechanically worked to form a cooked cereal dough. The cooking and mechanical work can occur simultaneously or sequentially. The dry ingredients can also include various additives such as sugar(s), salt and mineral salts, e.g., trisodium phosphate, and starches. In addition to water, various liquid ingredients such as corn (maize) or malt syrups can be added. A cooked cereal mash is quite similar except that larger sized particles such as whole grains or cut grains are cooked rather than cereal flour ingredients.

Broadly, the present invention provides food compositions that essentially comprise a cooked cereal dough or cereal having about 10 to 35% moisture. The amount of moisture depends, in part, upon the particular cereal ingredients, desired intermediate or finished products, cooking equipment and techniques employed.

The cereal cooking art is replete with methods and techniques for preparing a cooked cereal dough and the skilled artisan will have no difficulty in selecting suitable methods and equipment for practicing this step. In one preferred variation, a twin screw extruder is employed to which the various dry ingredients and moisture are added and are combined with mechanical work and supplemental heating, if desired hydrate and cooked the cereal ingredients and to work the cooked cereal ingredients to form a cooked cereal dough. In still other embodiments, the various cereal ingredients are combined and slowly cooked with minimal shear in one or more batch cookers to form a cooked cereal dough or mass.

The cereal dough cooking step can be practiced using a batch, atmospheric cooker and a low pressure extruder cooker especially those equipped with a conditioner precooker, or a twin screw extruder. The cereal ingredients are cooked with steam and sufficient amounts of added water for times and at temperatures sufficient to gelatinize the cereal starch and to develop desired levels of cooked cereal flavor.

Since inulin does not require cooking, the inulin can be added either before or after cooking. Thus, in one preferred embodiment, the FOS such as inulin can be added to the cereal and other dry ingredients prior to cooking. The inulin bearing dry blend of cereal ingredients can then be combined with water, heated to cook and gelatinize the starchy constituents and mechanically worked to form a cooked cereal dough fortified with inulin.

Likewise, all or a portion of the vegetable protein can be added to the cereal dough after cooking to facilitate or speed the cooked cereal dough preparation. An advantage to the post cooking addition of all or a portion of the protein ingredient is in the reduction in heat exposure of the protein and thereby any resultant heat damage to the flavor and texture.

In one variation of this embodiment, the cereal ingredients are cooked in a cooker such as a single or twin screw cooker extruder to form a cooked cereal dough.

In another variation, since the inulin does not require cooking, a cooked cereal dough is prepared that does not include inulin. In this variation, the inulin is added afterwards to the cooked dough. Cooking cereal ingredients containing high levels of inulin can result in a sticky dough material that is difficult to work with. Accordingly, post cooking addition of all or at least a portion of the inulin allows for the convenient preparation of a cooked cereal dough minimizing or at least reducing handling problems associated with a high inulin level cooked cereal dough. The inulin post cooking can be added in solid form or dissolved in small or minimal amounts of water and admixed with the cooked cereal dough to form the inulin-fortified dough. The inulin addition can be practiced as a separate sub-step or combined with another sub-step. For example, conveniently, the inulin can be worked into the dough in a pellet-forming device that transforms the dough into individual sized and shaped pieces. In one variation, such pellets are spherical or rounded. These pellets can be then be flaked to form wet flakes and thereafter finished to provide the present R-T-E cereal products such as by toasting the wet flakes to form dried flakes having 1-5% moisture.

In still another variation, a portion of the inulin is added with the other dry cereal ingredients that are admixed with water, cooked and worked to form a partially fortified dough to reduce or minimize dough handling difficulties. Then, the balance of the inulin can be admixed with the dough to prepare an inulin containing dough fortified to desired levels. In still other variations, a portion of the total inulin level can be provided by the below described topical coating containing inulin. In still another variation, cooked cereal soughs having excessive levels of inulin are prepared. Thereafter, a small quantity of such high inulin level cooked cereal dough is admixed with a larger proportion of cooked cereal dough having no or low levels of added inulin. In this manner, the larger dough proportion can be processed in conventional manner without the difficulties of handling a sticky inulin containing cooked cereal dough. The smaller proportion inulin rich cooked cereal dough while difficult to handle will at least be in much smaller quantity.

Conveniently, as described above, inulin can be admixed with other dry cereal ingredients and water that is then cooked to form a cooked cereal dough. The high protein content cooked cereal dough containing high levels of both soluble and insoluble fiber so prepared is suitable for use as an intermediate product farinaceous such as in the commercial production of R-T-E cereal products. Forming into Desirably Shaped and Sized Pieces

The present methods can further comprise the step of forming the dough into individual pieces of desirable shape and size. Conventional techniques and equipment can be employed to practice this step and the skilled artisan will have no difficulty in selecting those suitable for use herein.

The present cereal compositions can be fabricated into any of a variety of common R-T-E cereal forms including biscuits, flakes, puffs, shreds, squares or any common R-T-E cereal or cereal based snack product form, shape or size. The present cereal compositions can also be formulated and fabricated so as to provide puff or puffed cereals of various shapes and sizes such as “O's”. Especially desirable for use herein are flakes, especially toasted flakes.

The present piece-forming step can itself include a number of sub-steps to practice specific embodiments. For example, a great number of R-T-E cereals and snack products are prepared from cooked cereal doughs that are formed into pellets. The cooked cereal dough can be fed to a pellet former to form pellets. The dough can be partially dried before pellet forming and also the pellets can be partially dried after pellet forming. For example, in the preparation of R-T-E cereals in flake form, the pellets are sized to have a pellet count of about 35 to 50 per 10 g and a moisture content of 15 to 20%.

In more preferred form, in the preparation of a flaked R-T-E cereal, the pellets can be partially dried to moisture contents of about 18 to 20%. The pellets can then be formed into “wet” flakes having a thickness of about 380 to 780 micron (“μm”) (0.015 to 0.03 inch), preferably about 380 to 635 μm (0.015 to 0.025 inch), preferably while warm about 75 to 90° C. (167 to 195° F.) to form desirably shaped and sized wet flakes.

In still another variation, the dough can be sheeted to form sheets of dough (e.g., 25 to 800 microns in thickness) and the individual pieces formed by cutting the sheet into individual pieces or by stamping out shaped pieces from the dough sheet.

In still another variation, the cooked cereal dough can be extruded through a die imparting a desired peripheral shape to form an extrudate cooked cereal dough rope. The dough rope can be cut to form individual shaped pieces.

In still another variation, the cooked cereal dough can be fed to a biscuit forming device (see, for example, U.S. Pat. No. 5,342,188, entitled “Device For Crimping and Cutting Dough Ropes, issued Aug. 30, 1994 to C. E. Zimmermann, which is incorporated herein by reference) which forms the dough into biscuit shaped individual pieces.

In another preferred variation, the cooked cereal dough is formed into individual “O” shaped or toroid shaped pellets or pieces or rings, biscuits, shreds, stars, figurines, letters, symbols, numbers, spheres or other geometric shapes, nuggets, or even irregular shapes.

The size or weight of the individual pieces can vary depending in part upon the desired end use application. For example, the finished form can be in the form of flakes suitable for use as an R-T-E cereal. Such products can have higher piece counts such as 30-150 per 10 grams. In other variations, the flakes can be thicker (0.5-2 mm) and larger suitable for preparing grain based snack products such as by deep fat frying to form chips. Such products can have smaller piece counts such as 1-10 per 10 grams.

Drying To Form Finished Pieces

The present methods can further comprise the step of drying the shaped and sized individual pieces to form finished cereal products containing high levels of both fiber and protein.

The skilled artisan will appreciate that the particular technique for practicing the drying step depends in important part upon the desired end product. For example, for end products in the form of puffable half products or pellets for snack production, the drying step can be practiced to provide a finish moisture content of about 10 to 15%. However, when the desired end product is an R-T-E cereal, drying the pellets to these moisture contents may only be an intermediate or sub-step prior to, for example, flaking the dried pellets to form “wet” flakes. These “wet” flakes can then be subjected to a finish or final drying step wherein the pieces are dried to final dried moisture contents of 1 to 4% such as by toasting.

In still another variation, the dough can be extruded under conditions of temperature and pressure so as to puff and expand (the “direct expansion” technique) and sectioned or cut into individual pieces to form individual expanded puffed R-T-E cereal or snack pieces.

In another variation, the drying step can involve heating the pieces under conditions that not only dry the piece but also cause the piece to expand to form dried and puffed or flaked finished pieces. For example, pellets can be gun puffed to form dried puffed R-T-E cereal products having a density ranging from about 0.15 to 0.5 g/cc. The wet flakes can be toasted to dry, expand and tenderize to form finished R-T-E cereal flakes.

The skilled artisan will appreciate that the drying step depends in important part upon the desired end product. For example, for end products in the form of puffable half products or pellets for snack production, the drying step can be practiced to provide a finish moisture content of about 10 to 15%. However, when the desired end product is an R-T-E cereal, drying the pellets to these moisture contents may only be an intermediate or sub step prior to, for example, flaking the dried pellets to form “wet” flakes. These “wet” flakes can then be subjected to a finish or final drying step wherein the pieces are dried to final dried moisture contents of 1 to 4% such as by toasting.

In still another variation, the dough can be extruded under conditions of temperature and pressure so as to puff and expand (the “direct expansion” technique) and sectioned or cut into individual pieces to form individual expanded or puffed R-T-E cereal or snack pieces.

In another variation, the drying step can involve heating the pieces under conditions that not only dry the piece but also cause the piece to expand to form dried and puffed or flaked finished pieces. For example, pellets can be gun puffed to form dried puffed R-T-E cereal products. In another variation, wet flakes can be toasted to dry, expand and tenderize to form finished R-T-E cereal flakes. In still other variations, biscuit s can be baked to finish moisture contents of 2-6% to form finished biscuit shaped R-T-E cereals.

In still other variations the finish drying can be practiced by microwave heating or by radiant heating or infrared heating. In still other variations, the finish drying can be practiced by deep fat frying to provide a fried snack product.

In the preferred form, the finished dried high fiber high protein cooked cereal dough products are in the form of flakes suitable for an R-T-E cereal. The flakes can form a loose mixture of particles that can be packaged in conventional manner for distribution and sale as a packaged consumer food item. In still other variations, a quantity of the finished particles are combined with a binder such as a sugar binder and formed into a cereal bar.

In commercial practice, one or more of the present methods' steps can be combined and performed in or by a single piece of equipment. For example, a dry mix of cereal ingredients including inulin can be admixed with water and/or steam in a cooker extruder such as a single screw or twin screw. The cooker extruder heats, cooks and works the cereal ingredients to form an inulin containing cooked cereal dough. In one variation, referred to in the art as direct expansion, the extruder conditions are such that upon extrusion, the cooked cereal dough expands and dries and is severed into small pieces to form R-T-E cereal pieces. The R-T-E cereal pieces can be in final form. In slight variations, the R-T-E cereal pieces can be further dried to final moisture contents, especially if a sugar coating is applied.

Applying a Topical Coating

The present methods can additionally include a step of applying a topical coating to the dried cooked cereal dough pieces to form a coated dried cereal piece product. The cereal pieces, however formed, can optionally be provided with a topical coating and subsequently dried to remove the added moisture from the coating solution to form coated R-T-E finished cereal pieces. In one variation, the topical coating is a pre-sweetener coating intended to provide a sweet flavor to cereal base such as one having a sugar content of less than 2%. The pre-sweetener coating can include various sugars and/or high potency sweeteners such as aspartame, sucralose or potassium acesulfame. In other variations, an oil topical coating optionally with salt and/or flavors, is applied to form finished dried snack products.

The cereal pieces, however formed, can optionally be provided with a topical sugar coating and subsequently dried to remove the added moisture from the sugar coating solution to form presweetened R-T-E finished cereal pieces. In other variations, an oil topical coating optionally with salt and/or flavors, is applied to form finished dried snack products.

Surprisingly, all or part of the FOS especially inulin herein can be topically applied to form a topical coating. Conveniently, the inulin topical application step can be combined with the provision of the finished products herein with a topical sugar or presweetening coating. If the present inulin materials are topically applied in combination with the application of a topical presweetener coating, preferred for use herein are the FOS materials. Such FOS materials are preferred since such FOS materials impart a slightly sweet taste. Also, the FOS materials are highly soluble and lend themselves readily to such topical application.

If employed, the topical sweetening is applied in sufficient amounts such that after drying to remove added moisture associated with the sugar coating solution, the sugar coating is present in a weight ratio of sugar coating to cereal base of about 1:100 to about 150:100, preferably 10:100 to about 40:100. Typically, the sugar coating solution will have a blend of sugars and will comprise about 4 to 20% moisture. When higher amounts of the sugar coating solution, particularly for those solutions employing higher moisture levels, the slurry coated cereal pieces may be subjected to a final drying step to remove the added moisture from the sugar coating to provide finished dried products having a moisture content of about 1 to 5%.

In another variation, the topical coating application can include vitamin fortification especially of heat intolerant vitamins. For example, the finished dried flakes can then further vitamin fortified with heat labile vitamins A, D, and C by an aqueous dispersion. The vitamins are added to the flakes in an enrober to obtain a finished product having about 2.5% moisture.

In those variations in which the inulin material is added to the sugar coating, the sugar coating slurry can comprise about 1 to 80% inulin, preferably about 30-50%. In other variations, the sugar coating solution is applied as one spray or stream onto the cereal base while simultaneously or concurrently applying the inulin such as in a separate aqueous solution. If added as a separate aqueous solution, then the inulin is present in that solution at its maximum solubility level so as to minimize moisture addition that must be subsequently removed by drying.

The R-T-E cereal pieces so prepared can then be conventionally packaged for distribution and sale.

The R-T-E cereals of the present invention can be consumed in a conventional manner to obtain the nutritional and physiological benefits of a high protein and high fiber cereal food. A surprising advantage of the present R-T-E cereals is that the fiber is nearly “invisible”, that is, even high levels of fiber are barely organoleptically discernible in the finished product.

The finished dried R-T-E cereal and cereal based snack products fabricated from the cooked cereal doughs herein are useful as fiber fortified food products. The products are characterized by good flavor, good texture and other favorable organoleptic attributes. Notwithstanding their highly acceptable taste, appearance and texture attributes, the products are nonetheless characterized as having high levels of protein and fiber. Notwithstanding the high levels of soluble fiber, the present finished products are remarkably free of the undesirably slimy mouth feel heretofore associated with finished dried cereal products high in soluble fiber content. Also, notwithstanding their high insoluble fiber content, the present products do not have a gritty texture even though they are low in fat content.

To provide finished dried cereal products having the desired textural attributes, the products should have a preponderance of insoluble fiber and can range up to 1.8:1, i.e., when the weight ratio of total insoluble to total soluble fiber ranges from about 1.05-1.8:1. Better results are obtained when the weight ratio of total insoluble to total soluble fiber ranges from about 1.1:1 to about 1.5:1 (i.e., about 1.1-1.5:1).

R-T-E cereals are further characterized as free of any absorbed fat.

In still other variations, bulk quantities of the finished R-T-E cereal pieces can be admixed with various dried particulate ingredients to provide blended R-T-E cereal products. Such dried particulate ingredients can include, for example, dried fruit pieces, nut or nut pieces, dried marshmallows, pretzels, agglomerated nut and cereal pieces or nuggets or clusters, and mixtures thereof. The blended R-T-E cereal products can comprise about 1% to about 50% added dried particulates, preferably about 15-35% added dried particulates and the balance the present dried R-T-E cereal pieces.

The R-T-E cereal pieces so prepared can then be conventionally packaged for distribution and sale.

A ready-to-eat cereal composition of the present invention having high levels of soluble fiber is prepared according to the following procedure. A dry blend, a wet blend and a sugar coating composition were separately prepared having the respective formulations:

| | |
|---|---|
| Ingredients | Weight % |

A. Dry Base Blend

| | |
|---|---|
| Whole wheat | 36.92 |
| Inulin | 12.40 |
| White wheat bran | 8.00 |
| Sugar | 7.50 |
| Wheat gluten | 30 |
| Salt | 1.50 |
| Guar gum | 1.20 |
| Vitamin blend | 0.40 |
| Trisodium phosphate | 0.08 |
| | 100.00% |

B. Malt Syrup Slurry

| | |
|---|---|
| Water | 92.00 |
| Cereal malt syrup | 7.90 |
| Food coloring | 0.10 |
| (e.g. Annatto) | |
| | 100.00% |

Sugar Slurry

| | |
|---|---|
| Sugar | 60.00 |
| Water | 28.20 |
| Honey | 6.00 |
| Brown sugar syrup | 5.00 |
| Salt | 0.80 |
| | 100.00% |

About 1000 kg of dry base ingredients are blended for approximately 15 minutes in a conventional ribbon blender. The dry salt and sugar are weighed out separately and added to the malt syrup slurry mixture. The vitamin blend is also weighed out separately. Sufficient quantities of the malt syrup slurry (about 0.5 kg slurry for each kg of dry base mixture), are prepared in a conventional steam jacketed mixing kettle. The dry base and the prepared slurry are then added to a rotating batch cooker. The base and slurry mixture are then rotated for about five minutes to allow adequate mixing. The ingredients are then cooked for 55 minutes at 25 psig (274 kPA) steam pressure with processing vents of pressure after 15 minutes and again after 35 minutes elapsed time. Following cooking, the cooked cereal dough is allowed to cool and is pelletized in a pelletizing extruder (Ambrette Co.). The vitamin blend is metered into the cooled dough prior to pelleting extrusion at a rate sufficient to result in a final concentration in the cereal of 0.36%. The pellets are then dried in a conventional pellet dryer to a final moisture of 23 to 27%, with a target moisture of 25%. The dried pellets are then tempered for 45 to 60 minutes at ambient temperature in a conventional tempering belt system. The tempered pellets are then flaked using standard cereal flaking equipment to a thickness of about 0.018 to 0.023 inches 457 to 584 μm). The wet flakes are then toasted at 204.4° C. (400° F.) in a cereal toaster. The toasted flakes are then coated with sufficient sugar slurry to produce a final product with approximately 10% added slurry.

The final product has a soluble fiber content of 3.3 g/oz and an insoluble fiber content of 3.2 g/oz. The total fat content is less than 2%. Upon consumption, the R-T-E cereal will exhibit a pleasing, typical bran cereal flavor and texture profile, without a gummy or slimy mouth feel.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims

1. A cooked cereal dough product high in total dietary fiber and in protein, comprising:
A. About 20% to 80% (dry weight) of the cooked cereal dough product of at least one starchy cereal ingredient;
B. sufficient amounts of at least one insoluble dietary fiber ingredient to provide a total insoluble fiber content of about 5-15% (dry weight);
C. sufficient amounts of at least one soluble dietary fiber ingredient to provide a total soluble fiber content about 5% to 15% (dry weight); and wherein the weight ratio of total insoluble to total soluble fiber ranges from about 1:1. to about 1.5:1; and,
D. sufficient amounts of a plant protein ingredient to provide a total protein content of about 15% to 30% (dry weight).

2. The cooked cereal dough product of claim 1 wherein at least a majority portion of the insoluble dietary fiber ingredient is provided by a cereal bran ingredient selected from the corn bran, wheat bran, rice bran and mixtures thereof.

3. The cooked cereal dough product of claim 2 wherein the cereal bran is added in a form having a particle size ranging from about 50 to 800 micron.

4. The cooked cereal dough product of claim 3 wherein the cereal bran has a particle size ranging from about 50 to 600 micron.

5. The cooked cereal dough product of claim 2 wherein the plant protein ingredient comprises wheat gluten, corn zein, defatted soy meal or flour, soy protein, soy protein isolate, and mixtures thereof.

6. The cooked cereal dough product of claim 5 wherein the plant protein comprises wheat gluten, corn zein and mixtures thereof.

7. The cooked cereal dough product of claim 6 wherein the food product is free of soy protein.

8. The cooked cereal dough product of claim 6 wherein a majority portion of the plant protein is wheat gluten.

9. The cooked cereal dough product of claim 6 in the form of a cooked cereal dough having a moisture content of about 15 to 35%.

10. The cooked cereal dough product of claim 2 in the form of a dried food piece having a moisture content of about 2%-6%.

11. The cooked cereal dough product of claim 10 wherein the dried food piece includes a topical coating.

12. The cooked cereal dough product of claim 2 wherein at least a portion of the inulin had a DP ranging from about 9-17.

13. The cooked cereal dough product of claim 12 wherein at least a portion of the inulin is provided in the sugar coating.

14. The cooked cereal dough product of claim 6 wherein the wheat gluten is non-vital wheat gluten.

15. The cooked cereal dough product of claim 2 in the form of flakes.

16. The cooked cereal dough product of claim 15 wherein the flakes have a thickness of less than 1 mm.

17. The cooked cereal dough product of claim 1 wherein the starchy cereal ingredient includes rice flour, wheat flour and mixtures thereof.

18. The cooked cereal dough product of claim additionally comprising about 0.1% to 1% of carboxymethyl cellulose

19. The cooked cereal dough product of claim 17 comprising about 18-22% total dietary fiber and about 18-22% wheat gluten.

20. The cooked cereal dough product of claim 15 wherein the flakes are dried having a moisture content of about 2% to 6%.

21. The cooked cereal dough product of claim of claim 16 wherein the flakes are wet having a moisture content of about 10% to 25%.

22. The cooked cereal dough product of claim 1 having a sugar content of less than 2%.

23. The cooked cereal dough product of claim 2 having a fat content of less than 2%.

24. The cooked cereal dough product of claim 2 additionally including about 0.5% to 4% salt.

25. The cooked cereal dough product of claim additionally including a topical coating.

26. The cooked cereal dough product of claim 25 wherein the topical coating includes inulin.

27. The cooked cereal dough product of claim 26 wherein the topical coating includes about 30% to 50% inulin.

28. The cooked cereal dough product of claim substantially free of wheat gluten.

29. The cooked cereal dough product of claim substantially free of corn zein.

30. A method for preparing a fiber fortified food product, comprising the steps of:
A. providing a cooked cereal dough comprising;
1. About 20% to 80% (dry weight) of the cooked cereal dough product of at least one starchy cereal ingredient;
2. sufficient amounts of at least one insoluble dietary fiber ingredient to provide a total insoluble fiber content of about 5-15% (dry weight);
3. sufficient amounts of at least one soluble dietary fiber ingredient to provide a total soluble fiber content about 5% to 15% (dry weight); and wherein the weight ratio of total insoluble to total soluble fiber ranges from about 1:1. to about 1.5:1; and,
4. sufficient amounts of a plant protein ingredient to provide a total protein content of about 15% to 30% (dry weight), and,
5. about 15% to 40% moisture;
B. forming the cooked cereal dough into sized shapes and pieces; and
C. drying the pieces to a water activity of about 0.1 to 0.30 to form dried cereal dough pieces.

31. The method of claim 30 wherein at least a portion of the soluble fiber is provided by inulin.

32. The method of claim 31 wherein the soluble fiber level is at least 2 g/oz (2 g/24.8 g).

33. The method of claim 17 wherein step A includes adding at least a portion of inulin to the dough after cooking.

34. The method of claim 33 wherein the moisture content of the cooked cereal dough ranges from about 10 to 35% by weight.

35. The method of claim 34 wherein in step C includes the sub-step of forming flaked pieces, and wherein in step C includes the sub-step of toasting the flaked pieces to form toasted, dried flaked R-T-E pieces.

36. The method of claim 35 wherein the method further includes:
D. providing a sugar coating to the flaked R-T-E pieces.

37. The method of claim 36 wherein the R-T-E cereal composition is of claim 2.

38. The method of claim 37 wherein the R-T-E cereal composition is of claim 8.

39. The method of claim 33 wherein step B includes the sub-step of forming the dough into pellets and wherein at least a portion of the inulin is added during pellet forming.

40. The method of claim 33 wherein at least a portion of the inulin is topically applied.

41. The method of claim 33 wherein at least a portion of the inulin is topically applied in a sugar coating.

42. The method of claim 20 wherein the β-2-fructofuranose includes inulin.

43. The method of claim 27 wherein the cooked cereal dough includes whole wheat.

44. The method of claim 19 wherein step D comprises deep fat frying whereby the dried cereal pieces are puffed to form puffed fried snack pieces.

45. The method of wherein step A includes adding at least a portion of protein to the dough after cooking.

46. The method of claim 30 wherein the cooked cereal dough includes a high potency sweetener.

47. The method of claim 46 wherein the high potency sweetener is selected from the group consisting of aspartame, sucralose, potassium acesulfame, and mixtures thereof.

48. The method of claim 47 wherein at least a portion of the high potency sweetener is sucralose.
